(19) United States
(12) Patent Application Publication
(10) Pub. No.: US 2014/0223274 A1
(43) Pub. Date: Aug. 7, 2014

(54) INFORMATION PROCESSING DEVICE AND INFORMATION PROCESSING METHOD

(71) Applicant: CANON KABUSHIKI KAISHA, Tokyo (JP)

(72) Inventor: Tomonori Nakamura, Kawasaki-shi (JP)

(21) Appl. No.: 14/153,123

(22) Filed: Jan. 13, 2014

(30) Foreign Application Priority Data
Feb. 1, 2013 (JP) 2013-018751

(51) Int. Cl. G06F 17/22

(52) U.S. Cl. CPC G06F 17/2235; G06F 17/2247
USPC 715/205; 715/234

(57) ABSTRACT

When an instruction to cause a first document being displayed on a display (108) to transition to a second document different from the first document is input, a relation determination section (115) determines a relevance between the second document and the first document. The relevance is determined based on, for example, a URL included in the first document. In a case where the two documents are relevant to each other, a document transition section (113) displays the second document on a display with a display attribute applied to the first document.

### BACKGROUND OF THE INVENTION

1. Field of the Invention

The present invention relates to a technology for enhancing usability expected when, for example, a screen transition is made between a plurality of documents by following a link on a Web browser.

2. Description of the Related Art

In a case where a Web site having one article formed of a plurality of pages is viewed on a Web browser, a reader follows a link (hyperlink) to a related page provided within a page, to thereby cause a transition of the displayed page, and views the subsequent part of the article. In that case, when a display has a small size as in a mobile terminal, visibility of content of the page may be improved by appropriately enlarging a portion of the article in the page by a multi-touch operation or the like.

Japanese Patent Application Laid-open No. 2002-183207 discloses a technology in which, when an instruction to advance the page to the next page is issued while book data is displayed with a specified range enlarged on the mobile terminal, article data placed in the same position of the next page is enlarged and displayed. This reduces time and labor for an enlargement operation performed by a user.

However, the technology disclosed in Japanese Patent Application Laid-open No. 2002-183207 is targeted at one piece of book data. Therefore, when a large number of links to pages other than the subsequent part of the article exist as in a Web site, for example, the following problem occurs.

That is, there is a problem in that, when a transition is made to the page irrelevant to the article after the article is viewed by enlarging the page, an area containing the article in the previous page is enlarged and displayed even though it is not necessary to enlarge and display the page in the first place.

### SUMMARY OF THE INVENTION

An embodiment of the present invention provides an information processing device for solving the above-mentioned problem. The information processing device includes: a reception unit configured to receive an instruction to cause a display subject being displayed on a display screen to transition from a first document to a second document different from the first document; a relation determination unit configured to determine whether or not the second document is a document related to the first document based on information included in the first document; and a display control unit configured to display the second document on the display screen with a display attribute applied to the first document on the display screen in a case where the reception unit receives the instruction for the transition to the second document determined to be related to the first document by the relation determination unit.

Further features of the present invention will become apparent from the following description of exemplary embodiments (with reference to the attached drawings).

### BRIEF DESCRIPTION OF THE DRAWINGS

FIG. 1A is a hardware configuration diagram of an information processing device according to a first embodiment of the present invention, and FIG. 1B is a functional configuration diagram thereof.

FIG. 2A is a flowchart illustrating an overall operation procedure example of the information processing device, FIG. 2B is a flowchart illustrating a procedure example of processing for finding a link to a related document, FIG. 2C is a flowchart illustrating a detailed procedure example of processing for recording a display attribute, and FIG. 2D is a flowchart illustrating a detailed procedure example of processing for applying the recorded display attribute.

FIG. 3A is a diagram illustrating a specific example of a Web browser, FIG. 3B is a diagram illustrating a transition example of the Web browser, and FIGS. 3C to 3F are diagrams illustrating another transition example of the Web browser.

FIG. 4 is a diagram illustrating a specific example of a source code of an HTML file.

FIG. 5A is a flowchart illustrating a procedure example of processing for finding a link to a related document according to a second embodiment of the present invention, and FIG. 5B is a flowchart illustrating a procedure example of processing for finding a link to a related document according to a third embodiment of the present invention.

FIG. 6 is a functional configuration diagram of an information processing device according to a fourth embodiment of the present invention.

FIG. 7 is a flowchart illustrating an example of processing for finding a link to a related document according to the fourth embodiment.

### DESCRIPTION OF THE EMBODIMENTS

Now, embodiments of the present invention are described with reference to the accompanying drawings.

In a first embodiment of the present invention, a description is made of an example of a portable information processing device (computer) for displaying a Web site having one article formed of a plurality of documents. In such a device, a limitation is often imposed on a display amount on a display screen. The following device according to the first embodiment is configured to be able to change a display size and a display position of the document displayed on the display screen. Note that, the “document” includes words, phrases, numerals, symbols, sentences, images, and other such objects. A so-called page is also included in the “document”.

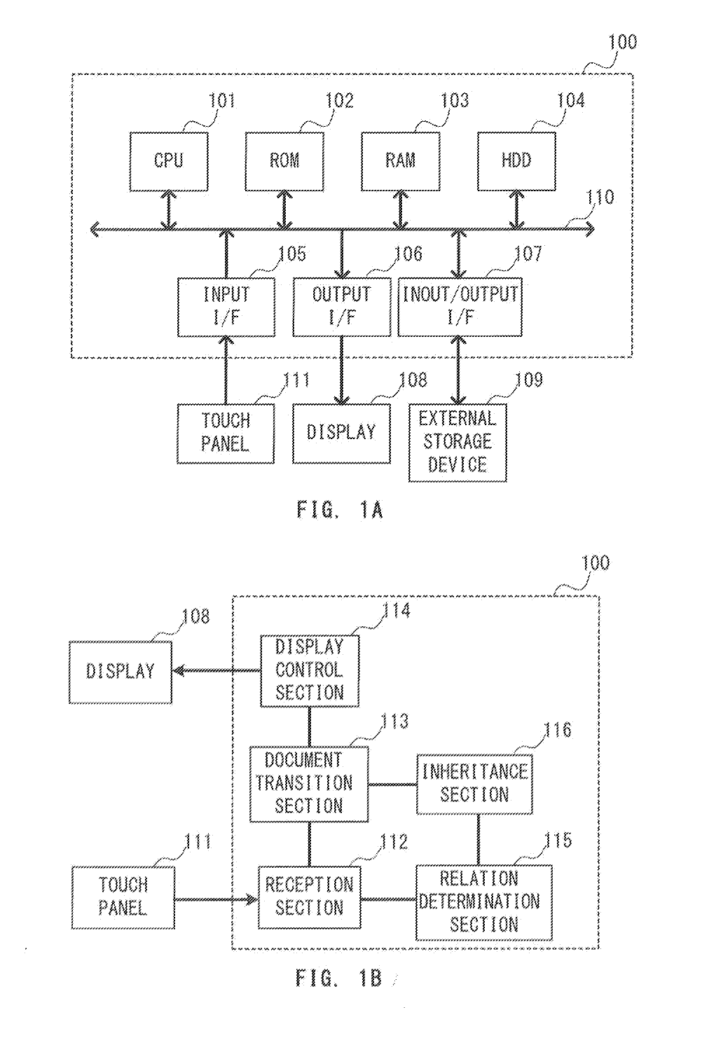

FIG. 1A is a diagram illustrating an example of a hardware configuration of an information processing device 100 according to this embodiment. A CPU 101 is a central processing unit (CPU), and performs arithmetic operations, logical decisions, and the like for various kinds of processing, to control respective components connected to a system bus 110. The information processing device 100 is mounted with a memory including a program memory and a data memory. A read-only memory (ROM) 102 is the program memory, and stores a computer program for control performed by the CPU, which includes various processing procedures described later. A random access memory (RAM) 103 is the data memory, and includes a work area used by the CPU 101 during execution of the above-mentioned computer program, a save area for data at a time of error processing, and a load area for the above-mentioned control program.

The program memory may be realized by loading the above-mentioned computer program or the like onto the RAM 103 from an external storage device 109 or the like. An HDD 104 is a hard disk drive for storing various kinds of data and the computer program. In this embodiment, the HDD 104 is configured to store image data and text data. As a device providing the same function, the external storage device 109 connected through an input/output interface (hereinafter “interface” is abbreviated as “I/F”) 107 may be used.

Here, the external storage device 109 can be realized by, for example, a medium (recording medium) and an external storage drive for realizing access to the medium. As such a medium, there is known, for example, a flexible disk (FD), a CD-ROM, a DVD, a USB memory, an MO, or a flash memory. Further, the external storage device 109 may be a server device or the like connected through a network. The information necessary in this embodiment is retained in the RAM 103, the HDD 104, and the external storage device 109.

An input I/F 105 acquires a signal input through a touch panel 111. With this configuration, the input I/F 105 recognizes a touch on the information processing device 100 and notifies a system of the signal. An output I/F 106 outputs an execution result of various kinds of processing described later to an output device including a display 108.

In this embodiment, the touch panel 111 employs a capacitive system, and a set of coordinates of one point within a touch plane between a user and a panel surface is identified as a touch point. However, a system employed by the touch panel 111 is not limited to the capacitive system. Further, this embodiment is described on the assumption that a touch panel display obtained by integrating the touch panel 111 and the display 108 is used. A Web browser is displayed on the touch panel display.

FIG. 1B is a functional configuration diagram of the information processing device 100. A reception section 112 includes the CPU 101, the ROM 102, and the RAM 103 (hereinafter referred to as “CPU and the like”). In this embodiment, based on the signal notified of by the input I/F 105, the information processing device 100 detects the coordinates of the point on the touch panel 111 touched by the user. Then, the reception section 112 receives such an event as an instruction for a screen transition in which a document indicated by a link associated with the object displayed in the coordinates is designated as a display subject to be displayed next. Here, the link represents information indicating a location of another document, an image, or the like embedded in the document, and is described in the document in association with a character, an icon image, or the like. For example, a uniform resource locator (URL) on the World Wide Web (WWW) corresponds to the link. Note that, the instruction to cause the transition of the display subject by designating the link based on such touch coordinates is expressed below by being abbreviated as “designation of the link”. Further, the document whose location is indicated by the designated link is referred to as “document of the link”.

A relation determination section 115 is formed of the CPU and the like, and determines whether or not the document of the link whose designation has been received by the reception section 112 relates to the document being displayed on the display 108 based on information on the link. In this embodiment, the link is the URL within the document (Web page described in HTML), and hence the relation determination section 115 performs the determination based on a character string included in the URL or the object name with which the link is associated. Note that, the “HTML” is an abbreviation of “hyper text markup language”.

An inheritance section 116 is formed of the CPU and the like, and causes the document after the transition to inherit a display attribute applied to the document before the transition when the relation determination section 115 determines that the document of the link designated by the reception section 112 relates to the document displayed on the display 108. In this embodiment, the inheritance section 116 records the display attribute applied to a first document, and notifies a document transition section 113 that the document after the transition is to inherit the display attribute before the transition. Here, “display attribute” represents, for example, a magnification applied when the document is displayed on the display 108, or a movement amount in a predetermined direction. In this embodiment, the related documents are assumed to have layouts similar to each other. Therefore, the inheriting of the display attribute in the transition to the related document eliminates the need to repeatedly set the display attribute for the document having the same layout.

The document transition section 113 is formed of the CPU and the like, and reads the document of the link designated by the reception section 112, to cause the display subject to transition to the document of the link. The “transition” represents, for example, interpreting an HTML code of the Web page existing in the location indicated by the URL of the designated link, a cascading style sheets (CSS) code therefor, a “JavaScript (trademark)” code therefor, or other such code, and extracting the interpreted information onto the Web browser. Then, the document transition section 113 notifies a display control section 114 of information necessary to draw the display screen after the transition and, when there is information on the display attribute notified of by the inheritance section 116, of the information.

The display control section 114 is formed of the CPU and the like, and generates a display image to be displayed on the display 108 based on the information acquired from the document transition section 113, to output the display image. Accordingly, the display subject within the browser application displayed in an entirety or a part of the display screen of the display 108 is caused to transition to the document of the designated link.

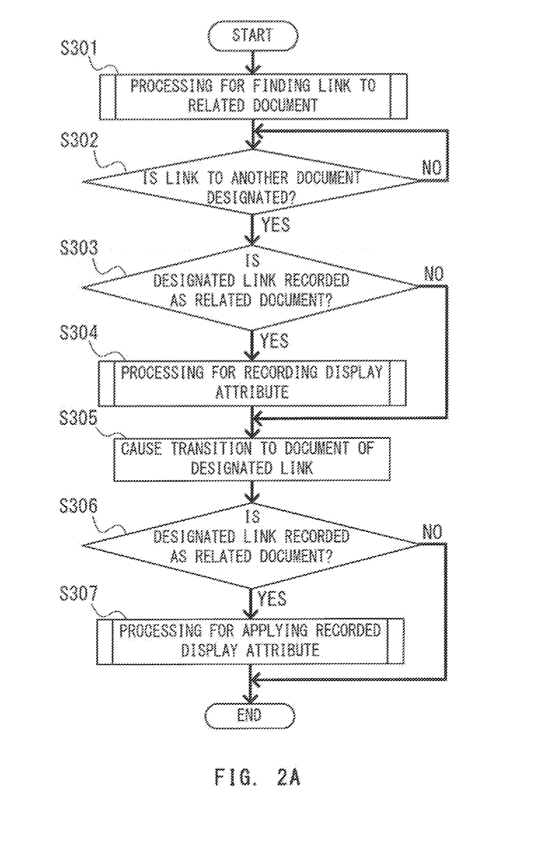

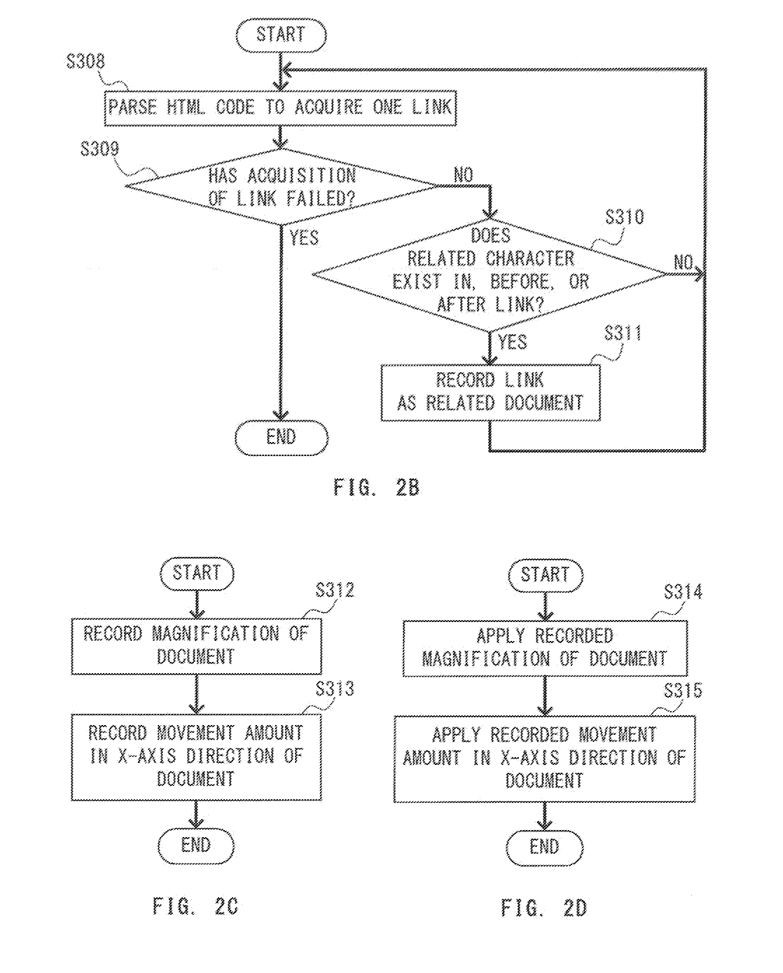

An operation of the information processing device 100 having the above-mentioned configuration is described with reference to FIGS. 2A to 2D. FIG. 2A is a flowchart illustrating a procedure example of processing performed when the display subject is caused to transition to another document of the link designated by the user after the information processing device 100 displays a new document.

In this embodiment, when the Web page is displayed as the document in the browser application, the processing of the flowchart illustrated in FIG. 2A is activated. First, the relation determination section 115 performs processing for finding a link to a related document (S301). Specifically, the relation determination section 115 searches links within a document (hereinafter referred to as “first document”) being displayed for a link to another document (hereinafter referred to as “second document”) related to the first document. When the link exists, the relation determination section 115 records the link as the link to the related document. This processing is described later in detail.

When the user performs a tap operation for the link on the touch panel 111, the information processing device 100 is notified by the input I/F 105 of the event indicating that the link to the second document has been designated by the user. The reception section 112 determines, based on presence/absence of the notification, whether or not the link to the second document has been designated by the user (S302). When the above-mentioned notification is absent, that is, when the link is not designated, the reception section 112 waits until the link is designated (S302: NO). When the link is designated, the relation determination section 115 determines whether or not the link is recorded as the related document in S301 (S303).

When the designated link is recorded as the related document (S303: YES), processing for recording the display attribute is performed (S304). In other words, the inheritance section 116 records the display attribute to be inherited among the display attributes applied to the first document. The processing executed here is described later in detail.

In S303, when it is determined that the designated link is not recorded as the related document (S303: NO), the document transition section 113 analyzes the document of the link designated in S302, in other words, the second document, extracts information thereon onto the Web browser, and causes the display subject to transition to the second document (S305). The display control section 114, which has acquired information relating to the drawing from the extracted information, generates the display image to be displayed on the display 108, and outputs the display image.

After that, in the same manner as in S303, the relation determination section 115 determines whether or not the link designated in S302 is recorded as the related document in S301 (S306). When the link is recorded, the inheritance section 116 notifies the document transition section 113 that the display attribute recorded in S304 is inherited by the second document. The document transition section 113 transmits the information on the display attribute notified of to the display control section 114, and causes the display control section 114 to output the display image to be displayed by setting the display attribute that has been notified of as the display attribute of the second document within the Web browser (S306: YES). The processing executed here is described later in detail. When the designated link is not recorded as the related document, the processing is brought to an end (S306: NO).

Details of the processing of S301 are described with reference to FIG. 2B. The relation determination section 115 parses (lexically analyzes) the HTML code of the first document to acquire one link (S308). Specifically, the relation determination section 115 searches the HTML code of the first document for an anchor element containing an “href attribute” indicating a link, to acquire one search result.

The relation determination section 115 determines whether or not acquisition of the link has failed in S308 (S309). The “acquisition of the link has failed” represents that there is no link left to be acquired in the HTML code of the current document. In this case, the processing is brought to an end (S309: YES). When the link is acquired, the relation determination section 115 determines whether or not a character (hereinafter referred to as “related character”) indicating that the document relates to the first document is attached to the link acquired in S308 (S310).

The related characters represent, for example, the character “NEXT” indicating the subsequent part of the first document and the character “PREV” indicating the document before the first document. Alternatively, the related characters may be, for example, “CONTINUE” and “BACK”. Further, the related character does not need to be limited to English, and another language may be used.

Specifically, “what is attached to the link” represents the value of the attribute within the anchor element for the link, the value of the attribute within a child element of the anchor element for the link, the value of the attribute within a parent element of the anchor element for the link, and the content of the anchor element for the link.

When the link acquired in S308 includes such a related character (S310: YES), the relation determination section 115 records the link as the related document for the first document (S311). When there is no related character in S310 (S310: NO), the procedure returns to S308.

FIG. 2C illustrates a detailed procedure example of the processing for recording the display attribute, which is executed in S304. In this processing, the inheritance section 116 records, for example, the magnification of the first document (S312) and the movement amount in an X-axis direction of the first document (S313) as the display attributes. The movement amount in the X-axis direction is, for example, “X1-X0” on the assumption that the top-left coordinates of the document are set to (X0, Y0) and that the coordinates of a character at the head of the article within the document are set to (X1, Y1). Note that, information in a Y-axis direction may be used together with the information in the X-axis direction.

FIG. 2D illustrates a detailed procedure example of the processing for applying the recorded display attribute, which is executed in S307. In the processing, the inheritance section 116 notifies the document transition section 113 of the magnification of the first document recorded in S312. The document transition section 113 causes the display control section 114 to output the display image on which the magnification that has been notified of is reflected. As a result, the inherited display attribute is applied to the second document to which the transition is made in S305 (S314).

Further, in the same manner, the movement amount in the X-axis direction of the first document recorded in S313 is applied to the second document to which the transition is made in S305 (S315). For example, when the value “X2” is recorded with the top-left coordinates of the first document set to (X0, Y0), the second document is displayed in the coordinates (X2+X0, Y0). Note that, the example is taken here in which, when the link to the second document related to the first document is included, the display image is generated and output by the display control section 114 in the respective processing steps of S305, S314, and S315. By thus performing redrawing each time the information is obtained, it is possible to present a quick response to the user's operation.

However, this embodiment is not limited thereto, and a final display image may be output only after the information on all the inherited display attributes has been obtained. In this case, it is possible to reduce frustration felt by the user when the redrawing is often repeated on a display.

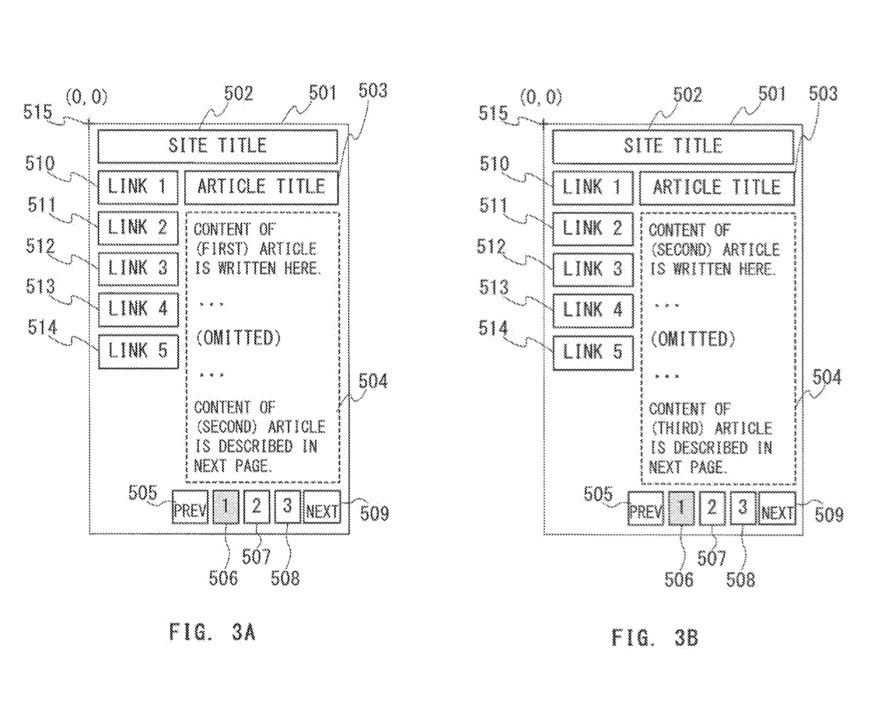

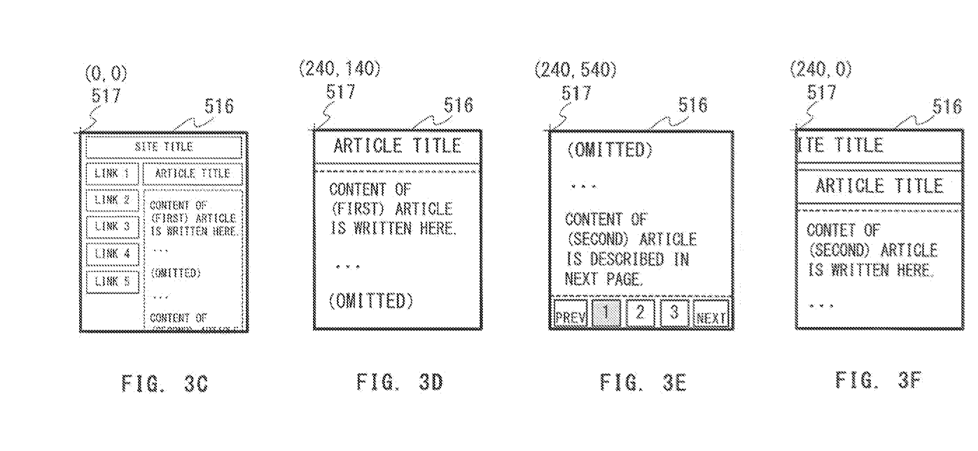

Next, a description is made of an example of the Web browser displayed by the information processing device 100. FIG. 3A illustrates a document 501, which is the first document of a Web site on which one article is formed of three documents. In the document 501, a site title 502, an article title 503, and content 504 of the current (first) article are displayed. Buttons 505 to 509 are buttons indicating links to the related documents that are related to the current article.

The “PREV” button 505 is the link to the document immediately before a number assigned to the current article. The document 501 exemplified in FIG. 3A is the first document of the three documents, and hence the previous document does not exist. Therefore, even when the “PREV” button 505 is designated by the user, nothing happens. That is, the transition of the document is not caused. The “1” button 506 is the link to the first document. Further, the “1” button 506 is displayed with an appearance different from the “2” button 507 or the “3” button 508. The “2” button 507 is the link to the second document. The “3” button 508 is the link to the third document. In contrast to the “PREV” button 505, the “NEXT” button 509 is the link to the document immediately after the number assigned to the current article. When the “NEXT” button 509 is designated by the user, the document is caused to transition to the second document.

Links 510 to 514 represent links to the documents irrelevant to the current article. Top-left coordinates 515 of the document 501 are (0, 0).

FIG. 3B illustrates the second document of the same article as in FIG. 3A. FIG. 3B is different from FIG. 3A only in the sentences within the content 504 of the article, the appearances of the “1” button 506 and the “2” button 507, and the links to the “PREV” button 505 and the “NEXT” button 509.

FIG. 3C illustrates a state in which the document 501 of FIG. 3A is newly displayed by the Web browser. An area 516 indicates a display area of the Web browser. The values of top-left coordinates 517 of the Web browser are (0, 0). In FIG. 3C, the partial area 516 of the document 501 is displayed. The partial area 516 is displayed with a magnification of 100%. The “processing for finding the link to the related document” of S301 illustrated in FIG. 2A is executed in such a state of display. The document displayed in FIG. 3C is the document 501 of FIG. 3A, and hence ten links exist therein. In other words, the ten links are the buttons 505 to 509, and the links 510 to 514.

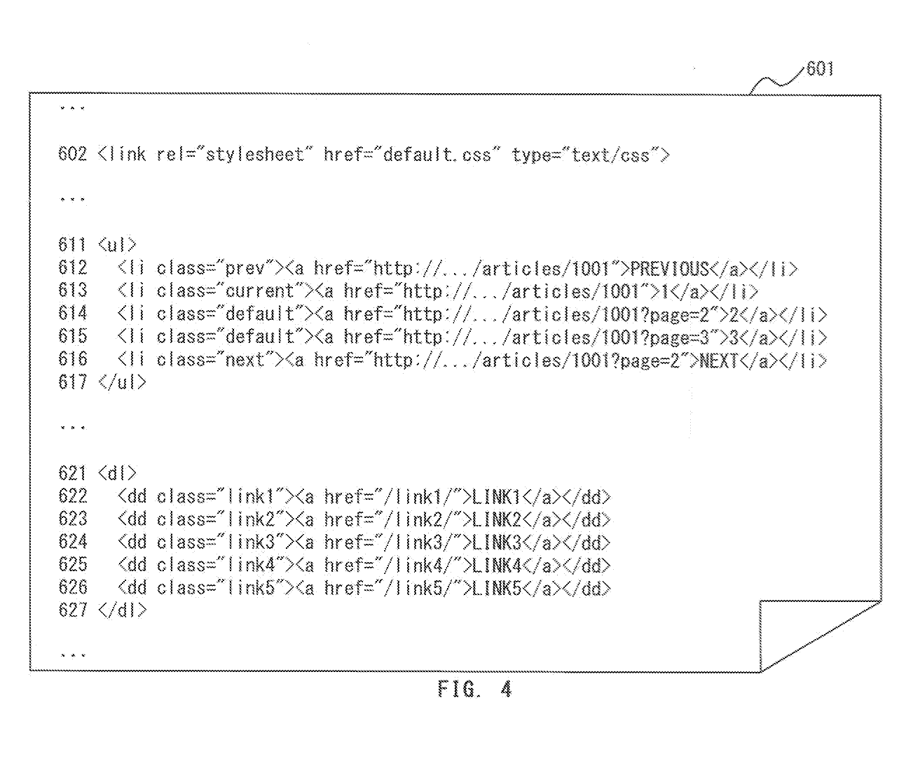

In the processing for finding the link to the related document, the HTML code of the document 501 is parsed to acquire one link. FIG. 4 illustrates a part of a source code of an HTML file 601 of the document 501. It is assumed that the URL of the HTML file 601 is “http:// . . . /articles/1001”. Lines 612 to 616 correspond to the buttons 505 to 509. Lines 622 to 626 correspond to the links 510 to 514.

When S308 is executed for the first time in FIG. 2B, the line 612 of FIG. 4 (button 505) is acquired. After that, the execution of S308 is repeated. When S308 is executed for the tenth time, the line 626 (link 514) is acquired. When S308 is executed for the eleventh time, no link exists and is therefore acquired.

Subsequently in S309, it is determined whether or not the acquisition of the link has failed in S308. In the example of FIG. 4, the line 612 (button 505) has been acquired, and hence the procedure advances to S310. In S310, it is determined whether or not the related character exists in, before, or after the link. Here, it is determined whether or not the related character exists in, before, or after the link corresponding to the line 612 (button 505). It is assumed that “NEXT”, “PREV”, “CONTINUE”, and “BACK” are recorded as the related characters in advance. In the example of FIG. 4, the value of the attribute (class) within the parent element (li) of the anchor element for the link is “prey”, and the content of the anchor element for the link is “PREV”. Therefore, it is determined that the related characters are included in the link, and the procedure advances to S311. In S311, the link corresponding to the line 612 (button 505) is recorded as the related document. When the above-mentioned processing is repeated, it is determined that the related character is also included in the line 616 (button 509). As a result, when the processing is brought to an end after failing to acquire the link in S309, the line 612 (button 505) and the line 616 (button 509) are recorded as the related documents.

FIG. 3D illustrates a state in which the user has explicitly performed a multi-touch operation or a double-tap operation to enlarge a part of the article from the state of FIG. 3C. At this time, the magnification is 169%, and the values of the top-left coordinates 517 of the Web browser are (240, 140). This indicates that an area within the document 501, which is spaced apart from the top-left coordinates 515 thereof by 240 in the positive X-axis direction and by 140 in the positive Y-axis direction, is displayed by the Web browser. In FIG. 3D, only the article title 503 and a part of the content 504 of the article are displayed.

FIG. 3E illustrates a state in which the user has read through the content 504 of the article to the last part by performing a flick operation or a drag operation to scroll down to the bottom from the state of FIG. 3D. At this time, the values of the top-left coordinates 517 of the Web browser are (240, 540). The magnification remains 169%.

FIG. 3F illustrates a state in which the user has designated a “NEXT” button from the bottom of FIG. 3E by the tap operation to cause a transition to the document that is the second page (second document) illustrated in FIG. 3B.

In relation to FIG. 2A, it is determined in S302 that the link to another document (second document) has been designated. The “NEXT” button is the link to the second document, and hence the procedure advances to S303. In S303, it is determined whether or not the designated link is recorded as the related document. The “NEXT” button 509 is recorded as the related document as illustrated in FIG. 2B and FIG. 4, and hence the procedure advances to S304.

In S304, the processing for recording the display attribute of the first document is executed. In other words, as illustrated in FIG. 2C, the magnification (169%) of the document is recorded in S312, and subsequently in S313, the movement amount (240) in the X-axis direction of the document is recorded.

Returning to FIG. 2A, in S305, the transition is made to the document indicated by the “NEXT” button. That is, the second document (FIG. 3B) indicating the second article starts to be drawn in the top-left coordinates (0, 0) of the Web browser with the magnification 100%. Subsequently in S306, the determination is performed to produce the same result as in S303, and the procedure advances to S307. In S307, processing for applying the recorded display attribute is executed. In other words, as illustrated in FIG. 2D, the recorded magnification (169%) of the document is applied (S314). Subsequently in S315, the recorded movement amount (240) in the X-axis direction of the document is applied. As a result, the values of the top-left coordinates 517 of the Web browser are (240, 0).

Accordingly, the user is allowed to read the subsequent part of the article only by scrolling down without having to explicitly perform a touch operation to cause the enlargement of the document or the movement in the X-axis direction thereof.

As described above, in the first embodiment, it is determined whether or not the first document relates to the second document of a transition destination. Then, the display attribute of the first document is inherited only when the transition is made to the second document determined to be related, and otherwise, the display attribute of the first document is not inherited. Accordingly, it is possible to prevent usability in viewing the document from deteriorating in a case where the display attribute of the first document should not be inherited.

Note that, in this embodiment, the processing for finding the link to the related document is performed in S301 when the transition is made to a new document, but may be performed after the link to the second document is designated.

Further, in this embodiment, the recorded display attribute of the first document is applied in S307 after the drawing is performed when the transition is made to the second document of the designated link in S305, but the recorded display attribute of the first document may be applied before the drawing of the second document of the transition destination is performed.

Further, in this embodiment, the description is made by assuming both the magnification of the document and the movement amount in the X-axis direction thereof as the display attributes to be inherited, but at least one thereof may suffice as the display attribute.

Further, in this embodiment, only the movement amount in the X-axis direction is recorded as the movement amount of the first document, but the movement amount in the Y-axis direction, which is obtained when the user explicitly performs the multi-touch operation or the double-tap operation to cause the enlargement, may be recorded and applied to the document of the transition destination. With this configuration, the top-left coordinates 517 of the Web browser illustrated in FIG. 3F become (240, 140), which can also eliminate the need to scroll down the site title 502.

Further, in the specific example of this embodiment, the operation performed when the transition is made to the document related to the article is described, but it should be understood that the operation performed when the transition is made to the document irrelevant to the article is to inhibit the magnification or the movement amount in the X-axis direction from being recorded or applied.

Further, in this embodiment, the description is made by taking the case where the input I/F 105 is the touch panel 111, but a mouse or other such pointing device may be applied. For example, in the case of the mouse, the enlargement illustrated in FIG. 3D can be realized by an operation of rotating a mouse wheel upward while holding down a Ctrl key of a keyboard. Further, the downward scroll illustrated in FIG. 3E can be realized by an operation of rotating the mouse wheel downward.

Further, in this embodiment, the character recorded in advance is used as the related character, but the related character can be additionally registered later.

In the first embodiment, a method of determining whether or not the related character exists in, before, or after the link is employed as the processing for finding the link to the related document. However, with such a method, in the case of the link to the second document related to the article without the related character, such as the case of the buttons 506 to 508 illustrated in FIG. 3A or FIG. 3B, the display attribute of the first document is not inherited even when the transition is made to the second document.

Therefore, in a second embodiment of the present invention, a description is made of an example of a case where a difference between the URL of the first document and the URL of the second document linked thereto is used in processing for finding a link to a related document.

A functional configuration of an information processing device according to the second embodiment is the same as the information processing device 100 according to the first embodiment illustrated in FIG. 1B, and hence a description thereof is omitted.

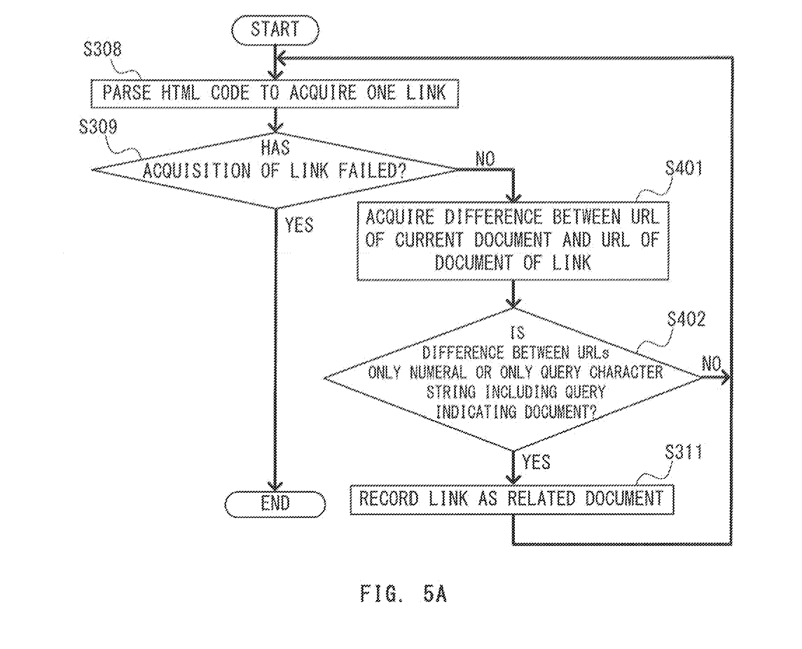

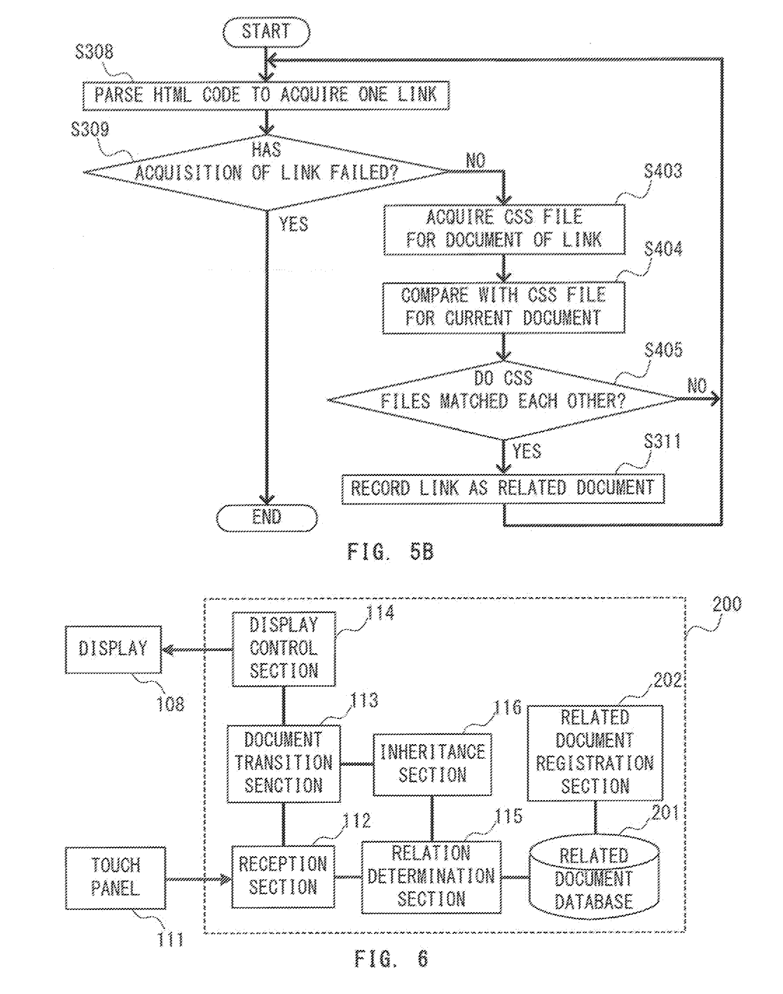

FIG. 5A is a flowchart illustrating a procedure example of the processing for finding the link to the related document according to the second embodiment. Compared with FIG. 2A illustrated in the first embodiment, S310 is removed, and S401 and S402 are added instead. The processing steps other than S401 and S402 are the same as those of the first embodiment, and hence descriptions thereof are omitted.

In S401, the relation determination section 115 acquires the difference between the URL of the current document and the URL of the document of the link acquired in S308. In that case, numerals are handled in groups. This means that, for example, in a case of acquiring the difference between the URLs “abc10.html” and “abc1.html”, only the numeral parts “10” and “1” are acquired as the difference.

When a comparison is performed character by character from the head instead of handling the numeral in groups, “0.html” is acquired as the difference, but this method is not employed here.

In S402, the relation determination section 115 determines whether or not the difference between the URLs acquired in S401 is only the numeral or only a request character string including a query indicating a document. The “query indicating the document” is, specifically, “?page=”. When the difference between the URLs is only the numeral or only the request character string including the query indicating the document, the procedure advances to S311. When the difference between the URLs includes a character other than those, the procedure returns to S308.

The details of characteristic processing according to the second embodiment are described in comparison with the first embodiment. The display example is described with reference to FIGS. 3C to 3F.

In FIG. 3C, assuming that the link (“2” button 507 of FIG. 3A and line 614 of FIG. 4) has been acquired in S308, the procedure advances to S401. In S401, the difference between the URL of the first document and the URL of the second document of the link is acquired.

The URL of the document 501 of FIG. 3A is “http:// . . . /articles/1001”, and the URL of the link corresponding to the line 614 (button 507) is “http:// . . . /articles/1001?page=2”. As the difference between those URLs, “?page=2” is acquired. Subsequently in S402, it is determined whether or not the difference between the URLs is only the numeral or only a query character string including the query indicating the document. The difference between the URLs is “?page=2”, which is the request character string including the query indicating the document, and hence, as a result of the determination, the procedure advances to S311. After those steps are repeated, when the processing is brought to an end after failing to acquire the link in S309, five links from the line 612 (button 505) to the line 616 (button 509) have been recorded as the related documents. That is, even when the user designates a “2” button in the state of FIG. 3E, the transition is made to the state of FIG. 3F.

In this manner, also in the second embodiment, it is determined whether or not the first document relates to the second document of the transition destination, and when the transition is made to the second document determined to be related, the display attribute of the first document is inherited. Accordingly, it is possible to produce the same effects as in the case of the first embodiment.

Note that, in the second embodiment, the description is made of the example in which the case where the URL of the document 501 includes the URL after the transition is used as a reference for determining the relation between the two documents, but the present invention is not limited thereto. For example, even when the URL of the first document is “http:// . . . /articles/1001?page=2” and the URL of the second document linked thereto is “http:// . . . /articles/1001?page=3”, those documents should be determined to be related to each other. Therefore, it suffices that a case where the URLs of the document corresponding to the first document and the document corresponding to the second document have such a relation that one URL includes an essential part of the other URL or other such case can be appropriately determined. The “essential part” is, for example, “http:// . . . /articles/1001?” in the above-mentioned example.

In a third embodiment of the present invention, a description is made of an example in which the determination is performed by comparing a style of the first document with a style of the second document of the link in processing for finding a link to a related document. A functional configuration of an information processing device according to the third embodiment is the same as the information processing device 100 according to the first embodiment illustrated in FIG. 1B.

FIG. 5B is a flowchart illustrating a procedure example of the processing for finding the link to the related document according to the third embodiment. Compared with FIG. 2A illustrated in the first embodiment, S310 is removed, and S403, S404, and S405 are added instead. The processing steps other than S403, S404, or S405 are the same as those of the first embodiment, and hence descriptions thereof are omitted.

In S403, the relation determination section 115 acquires at least one CSS (style sheet) file that defines the style of the second document of the link acquired in S308.

In S404, the relation determination section 115 compares the at least one CSS file acquired in S403 with at least one CSS file for the first document. The CSS files are compared with each other by determining whether or not every pair of files has the same file name between the at least one CSS file for the second document of the link and the at least one CSS file for the first document.

When, in S405, all the CSS files match each other as a result of the comparison between the CSS files for the second document of the link and the first document performed by the relation determination section 115 in S404, the procedure advances to S311. When there is a CSS file that does not match any other CSS files, the procedure returns to S308.

The details of characteristic processing according to the third embodiment are described in comparison with the first embodiment. The display example is described with reference to FIGS. 3C to 3F.

In the state of FIG. 3C, assuming that the link (“2” button 507 of FIG. 3A and line 614 of FIG. 4) has been acquired in S308, the procedure advances to S403. In S403, the CSS file for the second document of the link corresponding to the line 614 (button 507) is acquired. It is assumed here that “default.css” has been acquired. Subsequently in S404, the CSS file for the second document is compared with the CSS file for the document 501 of FIG. 3A, which is the first document. Referring to FIG. 4, information on the CSS file used by the document 501 of FIG. 3A, which is “default.css”, is written in the line 602.

Subsequently in S405, it is determined whether or not the CSS file for the document of the link (default.css) and the CSS file for the first document (default.css) match each other as a result of the comparison therebetween. Here, the CSS files for the two documents match each other, and hence the procedure advances to S311. After those steps are repeated, when the processing is brought to an end after failing to acquire the link in S309, five links from the line 612 (button 505) to the line 616 (button 509) have been recorded as the related documents. That is, also in this embodiment, even when the user designates a “2” button in the state of FIG. 3E, the transition is made to the state of FIG. 3F.

In this manner, also in the third embodiment, it is determined whether or not the first document relates to the second document of the transition destination, and when the transition is made to the second document determined to be related, the display attribute of the first document is inherited. Accordingly, it is possible to produce the same effects as in the case of the first embodiment.

Note that, there is also a method of using the appearance of the document, instead of the CSS file, for the processing for finding the link to the related document performed in S301. Specifically, there are a large number of Web sites having such a layout that buttons exhibiting meanings of “PREV”, “1”, “2”, “3”, and “NEXT” are arrayed in the last part of the article as illustrated as the respective buttons 505 to 509 in FIG. 3A. The symbols “>” or “→” may be used instead of “NEXT”, or the number of numerals may be five or ten instead of three. Even in such a case, the link may be determined as the link to the related document when the appearance exhibits a similar meaning.

In a fourth embodiment of the present invention, a description is made of an example in which the determination is performed by using a database, in which the URL of the first document and the link to the related document are registered, in processing for finding a link to a related document. FIG. 6 is a block diagram illustrating a functional configuration of an information processing device 200 according to this embodiment.

The information processing device 200 is different from the information processing device 100 according to the first embodiment in that the information processing device 200 includes a related document database 201 and a related document registration section 202.

The related document registration section 202 is formed of the CPU and the like, and registers the URL of the first document and the link to the second document related to the first document. The URL and the link are registered in the related document database 201. The other components are the same as those illustrated in FIG. 1B, and hence descriptions thereof are omitted.

The related document registration section 202 is formed of the CPU and the like, and registers the URL of the current document (the first document) and the link to another document related to the current document. The URL and the link are registered in the related document database 201.

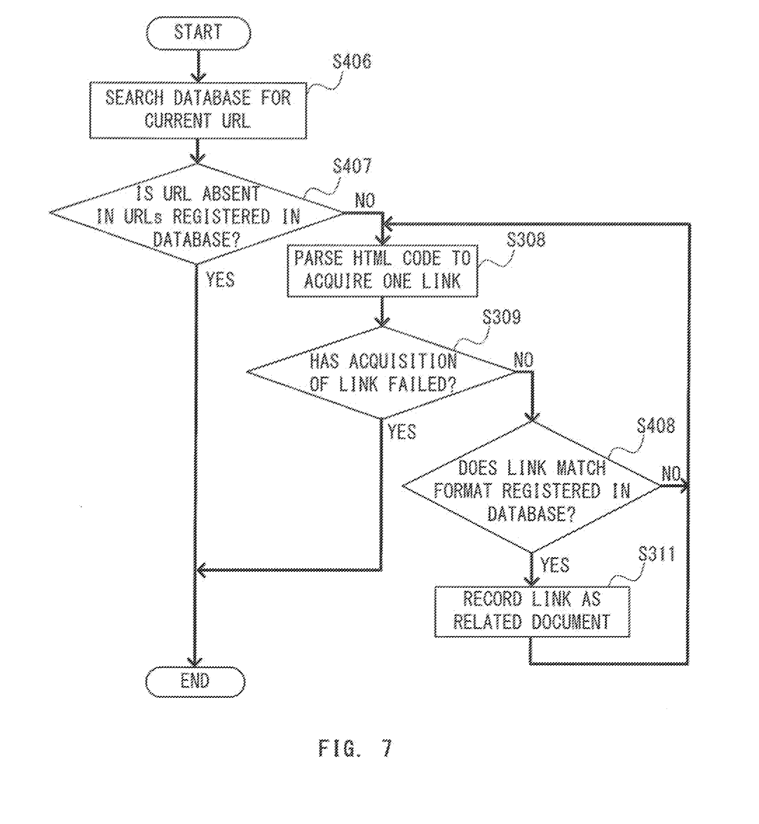

FIG. 7 is a flowchart illustrating a procedure example of the processing for finding the link to the related document according to the fourth embodiment. Compared with FIG. 2A illustrated in the first embodiment, S310 is removed, and S406, S407, and S408 are added instead. The processing steps other than S406, S407, and S408 are the same as those of the first embodiment, and hence descriptions thereof are omitted.

In S406, the relation determination section 115 searches the related document database 201 for the URL of the first document. It is assumed that, in the related document database 201, connections between the URLs of a large number of Web sites and the links to the related documents are described in advance in a fixed format such as XPath. Note that, any format can be used as long as the connections (correspondence relationships) are registered by using information that can identify a specific document or a document satisfying a specific condition.

In S407, the relation determination section 115 determines whether or not the URL of the first document is absent in the URLs registered in the related document database 201 searched in S406. When the URL is absent, it is assumed that the first document includes no link to the related document, and the processing is brought to an end (S407: YES). When the URL is registered, the procedure advances to S308 (S407: NO).

In S408, the relation determination section 115 determines whether or not the link acquired in S308 matches the format registered in the related document database 201. When the link matches the format registered in the related document database 201, the procedure advances to S311 (S408: YES). When the link does not match the format, the procedure returns to S308 (S408: NO).

A specific example thereof is described by focusing on the difference from the first embodiment.

In the state of FIG. 3C, processing for searching the related document database 201 for the URL of the first document is executed in S406. It is assumed here that the search is made for the URL “http:// . . . /articles/1001” of the document 501 of FIG. 3A. It is assumed that the URL “http:// . . . /articles/1001” is registered in advance in the related document database 201. As a result of the search, the URL of the document 501 of FIG. 3A is found to be registered in the related document database 201. Subsequently in S407, it is determined whether or not the URL of the document 501 of FIG. 3A retrieved in S406 is absent in the URLs registered in the related document database 201. Here, as a result of the determination, the procedure advances to S308.

In S308, in the same manner as in the above-mentioned embodiments, the link is acquired. Here, assuming that the line 614 (button 507) in FIG. 4 has been acquired, the procedure advances to S408. In S408, it is determined whether or not the link corresponding to the line 614 (button 507) matches the format registered in the related document database 201. Here, “//li[@class=“NEXT”]/a” is registered in the related document database 201 in the XPath format. Further, “//li[@class=“prev”]/a” is registered. In addition, “//li[@class=“current”]/a” and “//li[@class=“default”]/a” are registered. Those formats match the line 612 (button 505) to the line 616 (button 509) of FIG. 4. Therefore, as a result of the determination, the procedure advances to S311.

After those steps are repeated, when the processing is brought to an end after failing to acquire the link in S309, the five links from the line 612 (button 505) to the line 616 (button 509) have been recorded as the related documents. Therefore, even when the user designates the button 507 in the state of FIG. 3E, the transition is made to the state of FIG. 3F.

In this manner, also in the fourth embodiment, it is determined whether or not the first document relates to the second document of the transition destination, and when the transition is made to the second document determined to be related, the display attribute of the first document is inherited. Accordingly, it is possible to produce the same effects as in the case of the first embodiment.

Note that, as the processing for finding the link to the related document performed in S301, it is possible to employ an arbitrary combination of the ones according to the first embodiment to the fourth embodiment.

The present invention can also be realized by executing the following processing. That is, in the processing, software (program) for realizing the functions of each of the above-mentioned embodiments is supplied to a system or a device through the network or any one of various storage mediums, and the computer (or CPU, MPU, or the like) of the system or the device reads and executes the program.

According to the above-mentioned embodiments of the present invention, it is possible to enhance the usability in viewing the document by causing the second document to inherit the display attribute of the first document before the transition as necessary.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-018751, filed Feb. 1, 2013, which is hereby incorporated by reference herein in its entirety.

What is claimed is:

1. An information processing device, comprising:
a reception unit configured to receive an instruction to cause a display subject being displayed on a display screen to transition from a first document to a second document different from the first document;
a relation determination unit configured to determine whether or not the second document is a document related to the first document based on information included in the first document; and
a display control unit configured to display the second document on the display screen with a display attribute applied to the first document on the display screen in a case where the reception unit receives the instruction for the transition to the second document determined to be related to the first document by the relation determination unit.

2. An information processing device according to claim 1, further comprising an inheritance unit configured to record the display attribute applied to the first document on the display screen in a case where the reception unit receives the instruction for the transition to the second document determined to be related to the first document by the relation determination unit,
wherein the display control unit displays the second document on the display screen with the display attribute recorded by the inheritance unit.

3. An information processing device according to claim 1, wherein:
the display screen is capable of displaying the first document and the second document by changing a display size and a display position thereof; and
the display attribute applied to the first document comprises at least one of a magnification and a movement amount in a predetermined direction of the first document.

4. An information processing device according to claim 1, wherein:
the reception unit receives the instruction for the transition to the second document in a case where a link to the second document included in the first document is designated; and
the relation determination unit determines that the second document relates to the first document in a case where information indicating that the second document relates to the first document is attached to the link indicating the second document.

5. An information processing device according to claim 2, wherein the relation determination unit determines that the second document relates to the first document in a case where one of a URL of the second document of a link received by the reception unit and a URL of the first document includes an essential part of another one of the URLs.

6. An information processing device according to claim 1, wherein the relation determination unit determines that the second document relates to the first document in a case where a style of the second document matches a style of the first document.

7. An information processing device according to claim 1, further comprising a related document registration unit configured to register a correspondence relationship between the first document and the second document related thereto.

8. An information processing device according to claim 7, wherein the relation determination unit determines that the second document relates to the first document in a case where the first document is registered in the related document registration unit.

9. A computer-readable non-transient storage medium having stored thereon a computer program for causing a computer connected to a predetermined display screen to function as:
a reception unit configured to receive an instruction to cause a display subject being displayed on the predetermined display screen to transition from a first document to a second document different from the first document;
a relation determination unit configured to determine whether or not the second document is a document related to the first document based on information included in the first document; and
a display control unit configured to display the second document on the predetermined display screen with a display attribute applied to the first document on the predetermined display screen in a case where the reception unit receives the instruction for the transition to the second document determined to be related to the first document by the relation determination unit.

10. A method of inheriting a display attribute of a document, which is executed by a computer connected to a predetermined display screen, the method comprising:
determining, in a case where an instruction to cause a display subject being displayed on the predetermined display screen to transition from a first document to a second document different from the first document is received, whether or not the second document is a document related to the first document based on information included in the first document; and
displaying the second document on the predetermined display screen with a display attribute applied to the first document on the predetermined display screen in a case where the second document is the related document.

11. An information processing device, comprising:
a reception unit configured to receive an instruction to cause a display subject being displayed on a display screen to transition from a first document to a second document; and
a display control unit configured to:
display the second document on the display screen with a display attribute applied to the first document on the display screen in a case where the instruction for the transition to the second document having a layout similar to a layout of the first document is received; and
display the second document on the display screen with a display attribute applied to the second document on the display screen in a case where the instruction for the transition to the second document having a layout dissimilar from the layout of the first document is received.

12. An information processing device according to claim 11, wherein the display subject is displayed through a browser.

13. An information processing device according to claim 11, further comprising a similarity determination unit configured to determine whether or not the second document is a document having a layout similar to the layout of the first document based on information included in the first document.
